(19) United States
(12) Patent Application Publication
(10) Pub. No.: US 2011/0299083 A1
(43) Pub. Date: Dec. 8, 2011

(54) SAMPLE ANALYZING APPARATUS

(75) Inventor: Issei Yokoyama, Kyoto-shi (JP)

(73) Assignee: HORIBA, LTD, Kyoto-shi, Kyoto (JP)

(21) Appl. No.: 13/202,058

(22) PCT Filed: Jan. 7, 2010
(86) PCT No.: PCT/JP2010/050080

§ 371 Date: Aug. 17, 2011

(30) Foreign Application Priority Data
Feb. 18, 2009 (JP) 2009-035023

(51) Int. Cl. G01N 21/59

(52) U.S. Cl. 356/432

(57) ABSTRACT

Provided is a sample analyzing apparatus by which highly accurate measurement results can be obtained. The sample analyzing apparatus is provided with: a sample cell part constituting a plurality of cell spaces; light source parts that irradiate light in wavelength regions different from each other on the cell spaces; a plurality of collimator mirrors that are arranged to correspond to the cell spaces respectively and that collimate the transmitted light that has passed through the cell spaces; a diffraction grating that disperses the reflection light collimated by the collimator mirrors; a light collecting mirror that collects the light dispersed by means of the diffraction grating; and a light detector that detects the light collected by the light collecting mirror.

### FIELD OF THE ART

This invention relates to a sample analyzing apparatus that analyzes a component concentration in a sample by the use of the absorption spectrum obtained by irradiating the light on the sample and dispersing the transmitted light passing the sample.

### BACKGROUND ART

As this kind of the sample analyzing apparatus, as shown in the patent document 1, there is a sample analyzing apparatus that collects the light from a light source such as, for example, a halogen lamp, by a light condensing lens, irradiates the collected light on a sample cell, disperses the transmitted light passing the sample cell by the use of a diffraction grating, and then detects and calculates an absorption spectrum by a multichannel detector so as to analyze a component concentration of the sample.

In case of measuring the light absorption of the sample by the use of the sample analyzing apparatus, the absorbance 1 (transmittance 10%) through the absorbance 2 (transmittance 1%) is most appropriate as an amount of the light absorption. This is because a light amount of the transmitted light becomes too small for a case of more than or equal to the absorbance 2 so that it becomes difficult to measure the concentration with high accuracy due to an influence of the noise of a measurement system. Meanwhile, in case of less than or equal to the light absorbance 1, a change of the light absorption due to a change of a concentration of a contained component becomes too small so that it becomes difficult to measure the concentration with high accuracy.

For example, in case that the cell length (an optical path length inside of the cell) of the sample cell is 1 mm, it can be conceived that there is a sample whose absorbance is 0.1 for the irradiated light in a wavelength region A and whose absorbance is 1.0 for the irradiated light in a wavelength region B. Since the light absorption of the sample is in proportion to the concentration of the sample and the optical path length (based on the Beer-Lambert law), in a case that the optical path length of the sample cell is 10 mm, the absorbance of the irradiated light in the wavelength region A becomes 1, and the absorbance of the irradiated light in the wavelength region B becomes 10. In this case, a conventional sample analyzing apparatus conducts a measurement either by the use of the sample cell having the optical path length of 10 mm and the irradiated light in the wavelength region A or by the use of the sample cell having the optical path length of 1 mm and the irradiated light in the wavelength region B.

In case of measuring a complicated sample such as a multicomponent sample, the broader the wavelength region of the absorption spectrum is, the more the measurement accuracy of the concentration is generally improved. As a result, it is conceived that both measurements are conducted by the use of the sample cell having the optical path length of 10 mm and the irradiated light in the wavelength region A and by the use of the sample cell having the optical path length of 1 mm and the irradiated light in the wavelength region B. Concretely, in addition to designing the spectroscope that can measure the wavelength region of a broad range including the wavelength region A and the wavelength region B, the sample cell having two optical path lengths is moved by means of a mechanical moving mechanism.

However, with this method, since it takes time to switch the sample cell, there is a problem that it takes time to calculate the concentration. In addition, since it is necessary to conduct a measurement in the wavelength region of a broad range, in case of using the multichannel detector, a range of the wavelength per one channel of the detector becomes broad so that a wavelength resolution is aggravated.

In addition, it can be conceived that the sample cell and the detector are provided for each corresponding wavelength region. However, with this arrangement, a number of the components is increased, resulting in a problem that the cost is increased.

Furthermore, as shown in the patent document 2, there is an arrangement wherein two wavelength regions can be detected by a single array element (light detector). Concretely, a different opening is arranged for each corresponding wavelength region respectively and each of the openings is so set that a diffraction angle on a dispersive element to the center wavelength of a wavelength region becomes equal to the other diffraction angle.

However, this arrangement never considers a relationship between the optical path length and the wavelength of the irradiated light, and it is nothing more than just enlarging the measurable range of the wavelength with securing a desired wavelength resolution.

### PRIOR ART DOCUMENT

### Patent Document

Patent document 1: Japan patent document laid open disclosure number 2002-82050

Patent document 2: Japan patent document laid open disclosure number 8-254464

### DISCLOSURE OF THE INVENTION

### Problems to be Solved by the Invention

The present claimed invention intends to solve all of the problems and a main object of this invention is to reduce a number of the components as much as possible and to measure an absorption spectrum in more than two wavelength regions whose absorption rate (transmission rate) differs from each other by a cell length appropriate for each wavelength region so as to obtain the measurement result with high accuracy.

### Means to Solve the Problems

The sample analyzing apparatus in accordance with this invention is a sample analyzing apparatus that analyzes a component concentration of a sample by the use of an absorption spectrum obtained by irradiating light on the sample, and comprises a sample cell part constituting a plurality of cell spaces having mutually different cell length, a light source part that irradiates the light whose wavelength region is different from each other on each of the cell spaces, a plurality of collimator mirrors that are arranged to correspond to each of the cell spaces and that collimate transmitted light that has passed through the cell spaces, a diffraction grating that disperses reflected light collimated by the collimator mirror, a light collecting mirror that collects light dispersed by the diffraction grating, and a light detector that detects light collected by the light collecting mirror, and is characterized by that the plurality of the collimator mirrors are arranged so as to make an incident angle of the reflected light from each of the collimator mirrors to the diffraction grating different from each other.

In accordance with this arrangement, since the light in different wavelength regions is irradiated on multiple cell spaces whose cell length is different from each other, it is possible to obtain a highly accurate measurement result by measuring the absorption spectrum in more than two wavelength regions whose absorption rate (transmission rate) is different from each other by the use of the optical path length appropriate for each wavelength region. In addition, since each of the diffraction grating, the light collecting mirror, and the light detector is used in common, it is possible to reduce a number of the components as much as possible. Furthermore, since the collimator mirror is arranged to correspond to each cell space, it is possible to change the wavelength region detected by the light detector by adjusting a position of the collimator mirror so that the wavelength region tailored to an object to be measured can be detected with ease.

Especially, in order to measure the sample concentration with high accuracy by measuring the absorbance of the sample by the use of both the wavelength region where absorption by the sample is big and the wavelength region where absorption by the sample is small, it is preferable that a sample analyzing apparatus to analyze a component concentration of a sample by the use of an absorption spectrum obtained by irradiating light on the sample comprises a sample cell part that has a first cell space housing the sample and a second cell space whose cell length is shorter than that of the first cell space, a first light source that irradiates light in a wavelength region where absorption by the sample is small on the first cell space, a second light source that irradiates light in a wavelength region where absorption by the sample is big on the second cell space, a first collimator mirror that is arranged to correspond to the first cell space and that collimates transmitted light from the first cell space, a second collimator mirror that is arranged to correspond to the second cell space and that collimates transmitted light from the second cell space, a diffraction grating that disperses reflected light collimated by the first collimator mirror and the second collimator mirror, a light collecting mirror that collects light dispersed by the diffraction grating, and a light detector that detects light collected by the light collecting mirror, and is characterized by that an incident angle of the reflected light from the first collimator mirror to the diffraction grating is made to be different from an incident angle of the reflected light from the second collimator mirror to the diffraction grating.

In order to configure the first cell space and the second cell space by a single sample cell part with ease and to reduce a number of the components, it is preferable that the sample cell part is of a translucent tubular shape whose cross sectional view is a general rectangle, and forms the first cell space by side walls facing in a longitudinal direction and forms the second cell space by side walls facing in a lateral direction.

In addition, it is preferable that instead of the first light source and the second light source, light from one light source is separated into two luminous fluxes by use of an optical lens, and each luminous flux is irradiated on the first cell space and the second cell space respectively.

### EFFECT OF THE INVENTION

In accordance with this invention having the above-mentioned arrangement, it is possible to reduce a number of the components as much as possible and to measure an absorption spectrum in more than two wavelength regions whose absorption rate (transmission rate) differs from each other by a cell length appropriate for each wavelength region so as to obtain the measurement result with high accuracy.

### BRIEF DESCRIPTION OF THE DRAWINGS

FIG. 1 is a configuration diagram schematically showing a sample analyzing apparatus in accordance with this embodiment.

FIG. 2 is a schematic view showing an incidence angle and a diffraction angle of a reflected light to a diffraction grating.

FIG. 3 is a configuration diagram schematically showing a sample analyzing apparatus in accordance with a modified embodiment.

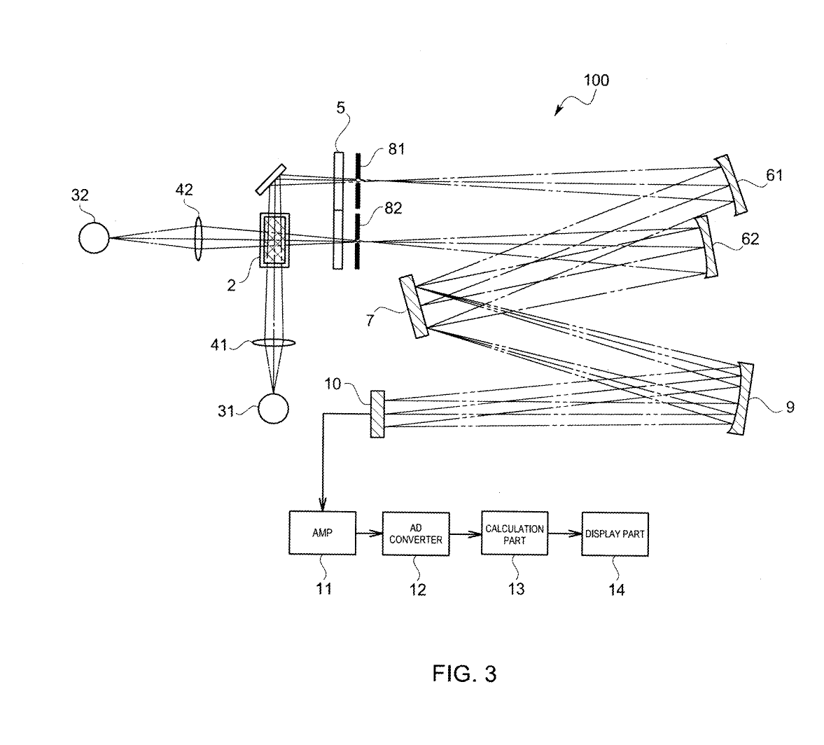

FIG. 4 is a view showing a modified embodiment of a sample cell part.

FIG. 5 is a configuration diagram schematically showing a sample analyzing apparatus in accordance with a modified embodiment.

### REFERENCE CHARACTER LIST

100 . . . sample analyzing apparatus
2 . . . sample cell part
S1 . . . first cell space
S2 . . . second cell space
31 . . . first light source
32 . . . second light source
61 . . . first collimator mirror
62 . . . second collimator mirror
7 . . . diffraction grating
9 . . . light collecting mirror
10 . . . light detector
α1, α2 . . . incidence angle

### BEST MODES OF EMBODYING THE INVENTION

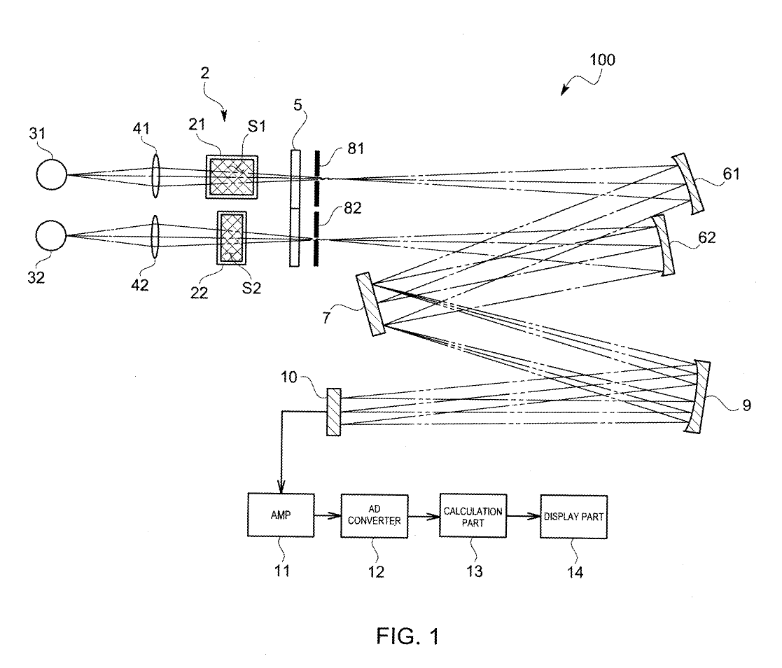

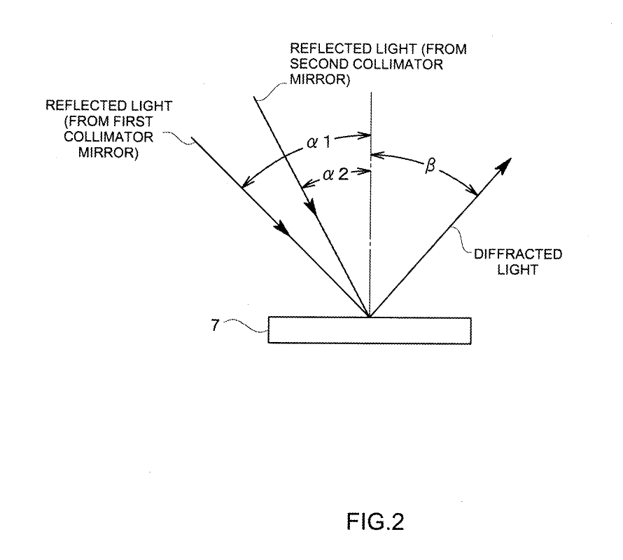

A sample analyzing apparatus 100 in accordance with this invention will be explained with reference to drawings. FIG. 1 is a configuration diagram schematically showing the sample analyzing apparatus 100 in accordance with this embodiment, and FIG. 2 is a schematic view showing incidence angles α1, α2 of a reflected light to a diffraction grating 7, and a diffraction angle β.

### <1. Apparatus Configuration>

The sample analyzing apparatus 100 in accordance with this invention comprises, as shown in FIG. 1, a sample cell part 2 that houses a sample, a first light source 31 and a second light source 32 that irradiate the light in a predetermined wavelength region on the sample cell part 2, a first collimator mirror 61 and a second collimator mirror 62 that collimate the transmitted light passing the sample cell part 2, a diffraction grating 7 that disperses the reflected light collimated by the first and the second collimator mirrors 61, 62, a light collecting mirror 9 that condenses the diffracted light dispersed by the diffraction grating 7, and a light detector 10 that detects the light condensed by the light collecting mirror 9.

The sample cell part 2 has a first cell space S1 that houses a sample and a second cell space S2 having a cell length (an optical path length) different from that of the first cell space S1. In this embodiment, the sample cell part 2 comprises a first sample cell 21 constituting the first cell space S1 and a second sample cell 22 constituting the second cell space S2. More concretely, the cell length of the second sell space S2 is made to be shorter than the cell length of the first cell space S1. Namely, a distance (a cell length) W1 between inner walls of the first sample cell 21 and a distance (a cell length) W2 between inner walls of the second sample cell 22 are so arranged to be W1>W2.

The first light source 31 is arranged to correspond to the first cell space S1 (the first sample cell 21), and irradiates the light on the sample housed in the first cell space S1. The first light source 31 is a continuous spectrum light source such as, for example, a halogen lamp. In addition, the first light source 31 irradiates the light in a wavelength region where absorption by the sample housed in the first cell space S1 is small. The light from the first light source 31 is condensed by the condensing lens 41 and then irradiated on the first cell space S1.

The second light source 32 is arranged to correspond to the second cell space S2 (the second sample cell 22), and irradiates the light on the sample housed in the second cell space S2. The second light source 32 is a continuous spectrum light source such as, for example, a halogen lamp. In addition, the second light source 32 irradiates the light in a wavelength region where absorption by the sample housed in the second cell space S2 is big. The light from the second light source 32 is condensed by the condensing lens 42 and then irradiated on the second cell space S2. The wavelength region of the light from the first light source 31 is different from the wavelength region of the light from the second light source 32. That the wavelength region is different may be that a part of the wavelength region of the light from the first light source 31 overlaps a part of the wavelength region of the light from the second light source 32, or that one wavelength region includes the other wavelength region, in addition to that the wavelength regions do not overlap each other.

A switch mechanism 5 is arranged between the first light source 31 and a slit 81 and between the second light source 32 and a slit 82 to switch the light from the first light source 31 and the light from the second light source 32 to be selectively irradiated on the first sample cell 21 or the second sample cell 22. The switch mechanism 5 comprises a mechanical shutter or the like and is controlled by a control part, not shown in drawings.

The first collimator mirror 61 is a concave surface mirror arranged to correspond to the first cell space S1 (the first sample cell 21), and reflects and collimates the light (the transmitted light) from the first light source 31 passing the first cell space S1.

The second collimator mirror 62 is a concave surface mirror arranged to correspond to the second cell space S2 (the second sample cell 22), and reflects and collimates the light (the transmitted light) from the second light source 32 passing the second cell space S1.

The diffraction grating 7 disperses the reflected light as the parallel light reflected by the first collimator mirror 61 and the second collimator mirror 62 for each wavelength.

Furthermore, a plurality of the collimator mirrors 61, 62 are arranged so as to make the incidence angle of the reflected light reflected by each of the collimator mirrors 61, 62 different from each other.

In other words, as shown in FIG. 2, the incidence angle al of the reflected light from the first collimator mirror 61 to the diffraction grating 7 is made to be different from the incidence angle α2 of the reflected light from the second collimator mirror 62 to the diffraction grating 7. More specifically, it is so arranged to be a relationship of the incidence angle α1>the incidence angle α2. And then, it is so arranged that the diffraction angle β of the reflected light incoming from the first collimator mirror 61 becomes generally the same as the diffraction angle β of the reflected light incoming from the second collimator mirror 62.

In addition, the slit 81 is arranged between the first sample cell 21 and the first collimator mirror 61 and the slit 82 is arranged between the second sample cell 22 and the second collimator mirror 62 in order to exclude stray light. Concretely, the slits 81, 82 are arranged at a position near a focus of a transmitted light so as to pass only the transmitted light that condenses at the focus.

The light collecting mirror 9 condenses almost all of the light dispersed by the diffraction grating 7 on a light detecting surface of the light detector 10, and comprises a concave mirror.

The light detector 10 is a multichannel detector that detects the light reflected and condensed by a concave mirror, such as the light collecting mirror 9, for each wavelength. A calculation part 13 (comprised of a CPU), into which a light intensity signal detected by the light detector 10 is input through an amplifier 11 and an AD convertor 12, is connected to the light detector 10. The calculation part 13 converts the light intensity signal into an absorption spectrum, and calculates a concentration value of a multicomponent of the sample based on the absorption spectrum. In addition, a display part 14 that displays the concentration value of the multicomponent obtained by the calculation part 13 is connected to the calculation part 13.

### <2. Effect of This Embodiment>

In accordance with the sample analyzing apparatus 100 of this embodiment, since the light in different wavelength regions is irradiated on each of the multiple cell spaces having a different cell length respectively, if the absorption spectrum of the sample in more than two wavelength regions whose absorbance (absorption degree) differs respectively is measured by an optical path length appropriate for each wavelength region, it is possible to obtain a highly accurate measurement result. More concretely, since the light in a wavelength region where the absorption by the sample is small is irradiated on the first cell space whose optical path length is small and the light in a wavelength region where the absorption by the sample is big is irradiated on the second cell space whose optical path length is big, it is possible to measure the component concentration of the sample with high accuracy. In addition, since each of the diffraction grating 7, the light collecting mirror 9, and the light detector 10 is used in common, it is possible to reduce a number of the components as much as possible. Furthermore, since each of the collimator mirrors 61, 62 is arranged to correspond to each of the cell spaces S1, S2, the wavelength region detected by the light detector 10 can be changed by adjusting each position of the collimator mirrors 61, 62 so that it is possible to easily detect the wavelength region tailored to an object to be measured.

### <3. Other Modified Embodiment>

The present claimed invention is not limited to the above-mentioned embodiment.

For example, the sample cell part 2 of the above-mentioned embodiment constitutes two kinds of the cell spaces by arranging two kinds of the sample cells; however, the sample cell part 2 may be a cylindrical shape whose cross-sectional view is a general rectangle having translucency wherein the first cell space S1 is constituted by side walls each facing in the longitudinal direction and the second cell space S2 is constituted by side wall each facing in the lateral direction. At this time, the first light source 31 is arranged to irradiate the light toward the side wall in the lateral direction, and the second light source 32 is arranged to irradiate the light toward the side wall in the longitudinal direction. With this arrangement, since the first cell space S1 and the second cell space S2 can be constituted by a single cell, it is possible both to simplify the apparatus configuration and to reduce a number of the components.

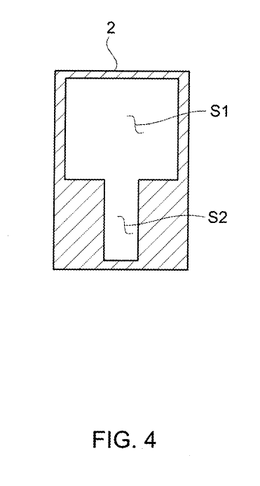

In addition, in a case that the sample cell part 2 is constituted by a single cell, the first cell space S1 and the second cell space S2 may be constituted by a cell having a wide width part and a narrow width part as shown in FIG. 4.

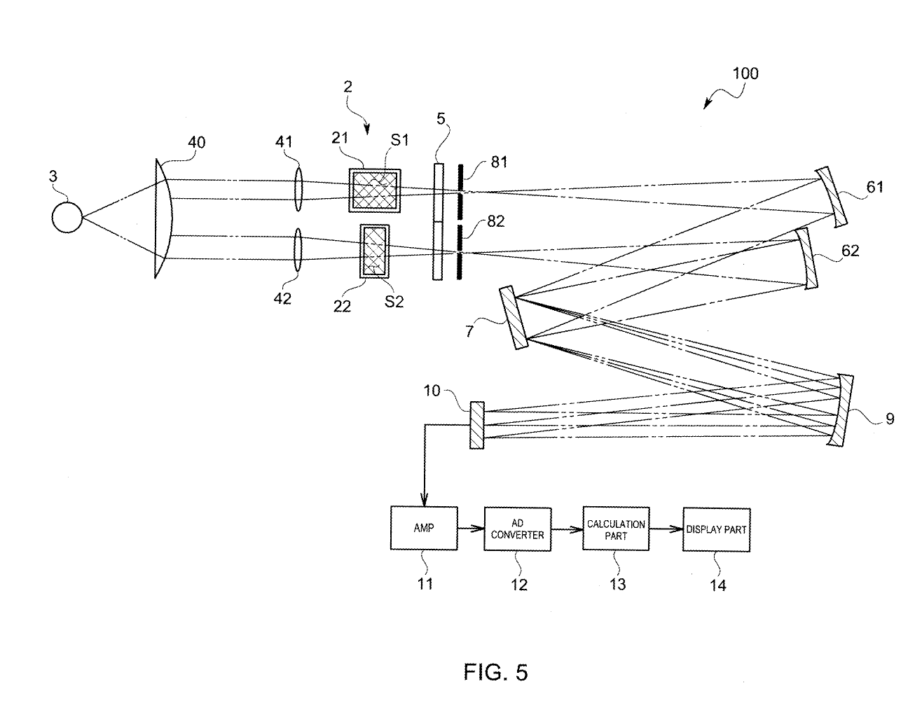

Furthermore, in the above-mentioned embodiment, the first light source and the second light source are arranged as the light source part, however, a single light source 3 may be arranged as the light source as shown in FIG. 5, and the light from the light source 3 is separated into two light fluxes by the use of an optical lens (a collimator lens 40 and light condensing lenses 41, 42 in FIG. 5) and each light flux is irradiated on the first cell space S1 and the second cell pace S2 respectively.

In addition, a part or all of the above-mentioned embodiment or the modified embodiment may be appropriately combined, and it is a matter of course that the present claimed invention is not limited to the above-mentioned embodiment and may be variously modified without departing from a spirit of the invention.

### INDUSTRIAL APPLICABILITY

In accordance with this invention, it is possible to reduce a number of the components as much as possible and to obtain a highly accurate measurement result by measuring the absorption spectrum in more than two wavelength regions whose absorption rate (transmission factor) differs from each other for the cell length appropriate to each wavelength region.

1. A sample analyzing apparatus to analyze a component concentration of a sample by use of an absorption spectrum obtained by irradiating light on the sample, comprising:
a sample cell part constituting a plurality of cell spaces having mutually different cell length,
a light source part that irradiates the light whose wavelength region is different from each other on each of the cell spaces,
a plurality of collimator mirrors that are arranged to correspond to each of the cell spaces and that collimate transmitted light that has passed through each of the cell spaces,
a diffraction grating that disperses reflected light collimated by the plurality of collimator mirrors,
a light collecting mirror that collects light dispersed by the diffraction grating, and
a light detector that detects light collected by the light collecting mirror, wherein
the plurality of the collimator mirrors are arranged so as to make an incident angle of the reflected light from each of the collimator mirrors to the diffraction grating different from each other.

2. A sample analyzing apparatus to analyze a component concentration of a sample by the use of an absorption spectrum obtained by irradiating light on the sample, comprising:
a sample cell part that has a first cell space housing the sample and a second cell space whose cell length is shorter than that of the first cell space,
a first light source that irradiates the light in a wavelength region where absorption by the sample is small on the first cell space,
a second light source that irradiates the light in a wavelength region where absorption by the sample is big on the second cell space,
a first collimator mirror that is arranged to correspond to the first cell space and that collimates transmitted light from the first cell space,
a second collimator mirror that is arranged to correspond to the second cell space and that collimates transmitted light from the second cell space,
a diffraction grating that disperses reflected light collimated by the first collimator mirror and the second collimator mirror,
a light collecting mirror that collects light dispersed by the diffraction grating, and a light detector that detects light collected by the light collecting mirror, wherein
an incident angle of the reflected light from the first collimator mirror to the diffraction grating is made to be different from an incident angle of the reflected light from the second collimator mirror to the diffraction grating.

3. The sample analyzing apparatus described in claim 2, wherein
the sample cell part is of a translucent tubular shape whose cross sectional view is a general rectangle, and forms the first cell space by side walls facing in a longitudinal direction, and forms the second cell space by side walls facing in a lateral direction.

4. The sample analyzing apparatus described in claim 2, wherein
instead of the first light source and the second light source, light from one light source is separated into two luminous fluxes by use of an optical lens, and each luminous flux is irradiated on the first cell space and the second cell space.
